(19) United States
(12) Patent Application Publication
(10) Pub. No.: US 2004/0199405 A1
(43) Pub. Date: Oct. 7, 2004

(54) Computerized system and method for modifying healthcare-related orders

(76) Inventors: Ellen Harper, Lake Waukomis, MO (US); Mallika Edwards, Fairway, KS (US); Lei Han, Overland Park, KS (US); Steven Kirsch, Prairie Village, KS (US); Troy J. Miller, Kansas City, MO (US)

Correspondence Address: SHOOK, HARDY & BACON LLP, 2555 GRAND BLVD, KANSAS CITY,, MO, 64108, US

(21) Appl. No.: 10/653,631

(22) Filed: Sep. 2, 2003

Related U.S. Application Data
(60) Provisional application No. 60/459,814, filed on Apr. 2, 2003.
(60) Provisional application No. 60/495,028, filed on Aug. 14, 2003.

(51) Int. Cl. G06F 17/60

(52) U.S. Cl. 705/2

(57) ABSTRACT

A system and method for modifying healthcare related orders is provided. Upon receiving one or more modifications to an existing order for a clinical agent the system updates the existing order to reflect said modifications. The system evaluates the modifications for validity and compatibility. The system also identifies historical information regarding modifications to the order.

### CROSS-REFERENCE TO RELATED APPLICATIONS

This application claims the benefit of U.S. Provisional Application No. 60/459,814, filed Apr. 2, 2003 and U.S. Provisional Application No. 60/495,028, filed Aug. 14, 2003.

### STATEMENT REGARDING FEDERALLY SPONSORED RESEARCH OR DEVELOPMENT

Not applicable.

### TECHNICAL FIELD

The present invention relates to the field of computer software. More particularly, the invention relates to a computerized system and method for modifying healthcare-related orders.

### BACKGROUND OF THE INVENTION

Clinicians oftentimes place a number of orders when providing care to a patient. An order is a request for one or more procedures to be performed. For example, an order may specify a particular medication, and the dosage, form, route and frequency of administration for that medication. After a medication order is placed, the order is validated and dispensed by a pharmacist and ultimately administered by the clinician or a member of the clinician's staff. Throughout the course of an episode of care, orders are frequently adjusted in response to the patient's changing condition. For example, elements of a medication order may vary due to an analysis of laboratory test results or the resultant effect of the medication on the patient's condition. For example, an order created to lower a patient's blood pressure may be changed during the course of treatment depending on clinical evaluations of the patient. Factors such as the current blood pressure, pain levels, temperature and potassium levels could necessitate an order change.

A number of healthcare information technology (HCIT) systems are currently available to receive and process clinical orders. The automation of traditionally manual processes in these HCIT systems has reduced the number of errors in the medication administration process. However, in the past, one limitation of the existing systems is the manner in which order changes are managed. Prior systems typically create a new record when an order is changed without disregarding the existing record. As a result, these systems maintain multiple discrete records in the patient's order history. It is difficult to associate and present these discrete records to a clinician to review the patient's history.

For example, as shown in FIG. 2, a screen shot illustrating an exemplary embodiment of a prior art system is shown. As illustrated by this example, the presentation is cluttered and very difficult to interpret. In this case, an order for morphine and an order for crystalline warfarin sodium (COUMADIN®) are initially placed for purposes of controlling pain and stabilizing the patient. During the episode of care, the physician modifies the dose of COUMADIN in response to the laboratory results or other circumstances. In addition, as the patient's level of pain changes, the physician changes the dosage of morphine to be administered.

Within the computerized system, the order modifications are recorded and summarized as shown in the historical view 200.

Specifically, an initial order for morphine is placed at 8:00 AM and the record for the order is viewable at an order display 201. The order is for two milligrams (2 mg) of morphine delivered through an intravenous push (IVP), that is to be given every two hours (Q2H), as needed (PRN) for pain. This order is set to expire at 10:00 AM. An initial order of COUMADIN is placed at 8:00 AM and the record for the order is viewable at an order display 202. This order is for five milligrams (5 mg) of COUMADIN, delivered orally (PO) by tablet (TAB), once a day (DALY). On June 18^{th} at 8:00 AM, the COUMADIN order is changed as reflected by the record viewable at an order display 203. This order is for 7.5 mg of COUMADIN with the same delivery and dosage frequency as the order displayed at order display 202. The record for the initial order of COUMADIN is marked as discontinued.

The morphine order recorded at display 201 is changed at 7:30 AM on June 18^{th} to a new order recorded at display 204. The end time for this order is 8:24 PM (or 20:24:00) on June 18^{th}. As modified, the new morphine order is for 4 mg of morphine delivered by injection or shot, every six hours as needed for pain. The record for the new morphine order at display 204 results in the discontinuation of the prior order (shown at display 201).

In another modification, at 6:34 PM (or 18:34:00) on June 18^{th}, a new order shown at display 206 is made to extend administration of morphine to 8:32 PM (or 20:32:00). Specifically, the order shown at order display 206 is for four mg of morphine, delivered orally (PO) every eight hours (Q8H), as needed (PRN) for pain. Also, the order recorded at display 204 is discontinued.

Finally, a new order for COUMADIN, shown at display 205, replaces the previous COUMADIN order shown at display 203, and the order at display 203 is discontinued. The order associated with order display 205 starts at 8 AM and specifies ten mg, delivered by tablet (TAB), orally (PO) once a day (DAILY).

As is demonstrated in FIG. 2, it is difficult to determine which order is continuing and which has been stopped simply by viewing historical view 200. As such, it is difficult to ascertain the progress of a patient's care.

It is desirable to allow a clinician to easily place order changes. Orders and any subsequent changes to the orders should be presented in a clear and cogent manner to reduce the likelihood of errors that may threaten the patient's safety. Furthermore, order changes should clearly convey when administration of the medication started, the duration of administration, the dosage of the medication, and the historical delivery schedule for the medication. Even further, it is desirable to simplify the workflow required to modify an order and study order history, particularly when such changes are not significant. Further still, it is desirable to streamline the verification and implementation of order changes for all of the involved caregivers.

### BRIEF SUMMARY OF THE INVENTION

Additional advantages and novel features of the invention will be set forth in part in the description which follows, and in part will become apparent to those skilled in the art upon examination of the following, or may be learned by practice of the invention.

In one aspect of the present invention, a method in a computing system for modifying healthcare-related orders is provided. The method receives one or more modifications to an existing order for a clinical agent. The method then updates the existing order to reflect said modifications. In one embodiment, the method evaluates the modifications for validity and compatibility. In another embodiment, the method identifies historical information relating to the modification of the existing order.

In another aspect of the present invention, a system in a computing environment for modifying health-care related orders is provided. The system has a receiving module for receiving one or more modifications to an existing order for a clinical agent. The system also has an updating component for updating the existing order to reflect the modifications.

In yet another aspect of the present invention, a method in a computing system for modifying healthcare-related orders is provided. The method includes means for receiving one or more modifications to an existing order for a clinical agent. The method also includes means for updating the existing order to reflect the modifications.

### BRIEF DESCRIPTION OF THE SEVERAL VIEWS OF THE DRAWING

The present invention is described in detail below with reference to the attached drawing figures, wherein:

FIG. 1 is a block diagram of a computing system including an order in accordance with an embodiment of the present invention;

FIG. 2 is a screen shot illustrating an exemplary general multi-step modification display of prior systems;

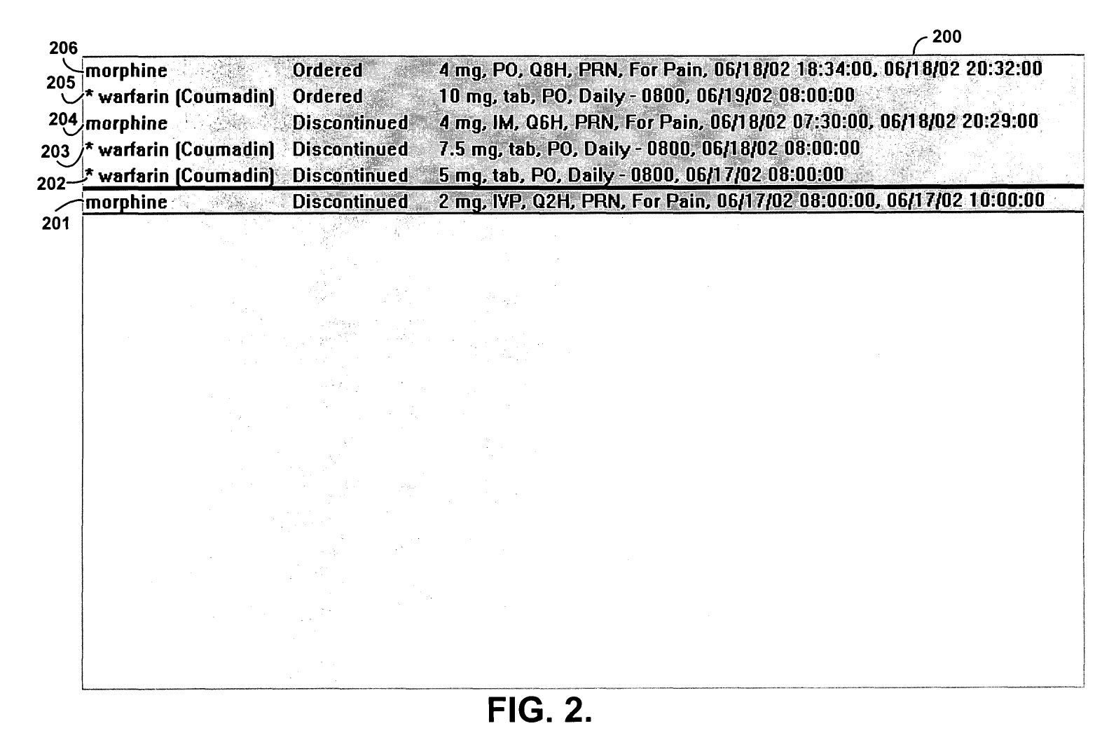

FIG. 3 is a flowchart representative of a computer program for the dynamically modifying orders in accordance with an embodiment of the present invention;

FIG. 4A is a screen shot illustrating an exemplary order system display of a patient's order profile with an entered order;

FIG. 4B is a screen shot illustrating a dynamic order modification display of the present invention;

FIG. 5A is a screen shot illustrating modified order details in accordance with an embodiment of the present invention;

FIG. 5B is a screen shot illustrating the order system display for a patient with the modified order of FIG. 5A; and

FIG. 6 is a screen shot illustrating the historical view of modifications made to an order in accordance with an embodiment of the present invention.

### DETAILED DESCRIPTION OF THE INVENTION

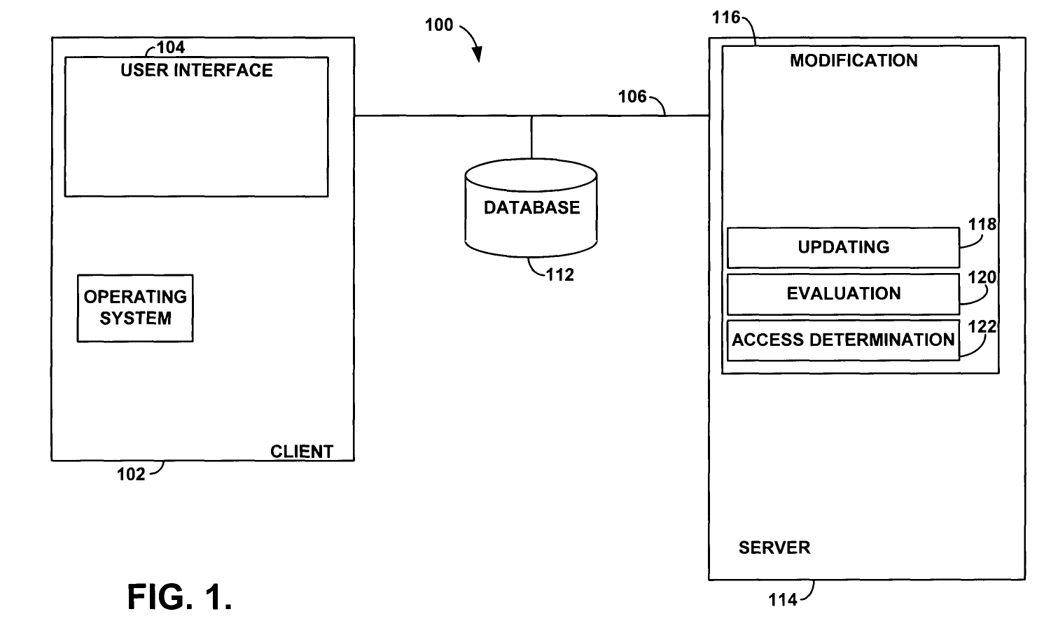

The present invention is directed to a method and system for dynamically modifying healthcare-related orders. FIG. 1 depicts an exemplary computer system 100 for dynamically modifying healthcare-related orders in accordance with the present invention. The system 100 is only one example of a suitable computing environment and is not intended to suggest any limitation as to the scope of use or functionality of the invention. Neither should the computer system 100 be interpreted as having any dependency or requirement relating to any one or combination of modules illustrated in the system 100.

The invention is operational with numerous other general purpose or special purpose computing system environments or configurations. Examples of well-known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include, but are not limited to, routines, programs, objects, components, and data structures that perform particular tasks or implement particular abstract data types. The invention may also be practiced in distributed computing environments where tasks are performed by remote processing devices that are linked through a communications network. In a distributed computing environment, program modules may be located in both local and remote computer storage media, including memory storage devices.

With continued reference to FIG. 1, the system 100 includes a general purpose computing device in the form of server 114. Components of server 114 may include, but are not limited to, a processing unit, internal system memory, and a suitable system bus for coupling various system components to one end. The system bus may be any of several types of bus structures, including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronic Standards Association (VESA) local bus, and Peripheral Component Interconnect (PCI) bus, also known as Mezzanine bus.

Client computers 102 provide a user interface 104 for enabling interaction by a clinician or the clinician's staff. Clinicians include, but are not limited to, the treating physician, specialists such as surgeons, radiologists and cardiologists, emergency medical technicians, physicians assistants, nurse practitioners, nurses, nurse's aides, pharmacists, dietitians and the like. In addition to other relevant information, orders are received and displayed via user interface 104 on client computer 102. As known in the art, the order is stored in one or more databases 112, which may reside on server 114. In operation, server 114 includes a modification module 116. In a preferred embodiment, the modification module 116 includes an updating sub-module 118 for updating an existing order with modifications input via the user interface 104, an evaluation sub-module 120 for evaluating the modification input via the user interface, and a data interface module 124. As would be understood by one skilled in the art, the modification module 116 can be separated into further sub-modules which may be executed on a single computer system or distributed across multiple systems. The data and computations processed by modification module 116 can also reside on one or multiple systems. From client computer 102, a clinician can access other relevant patient data associated with the order such as order details and order status.

Server 114 typically includes therein or has access to a variety of computer readable media, for instance, one or more databases 112. Computer readable media can be any available media that can be accessed by server 114, and includes both volatile and nonvolatile media, removable and non-removable media. By way of example, and not limitation, computer readable media may comprise computer storage media and communication media. Computer storage media may be implemented in any method or technology for storage of information, such as computer readable instructions, data structures, program modules or other data. Computer storage media includes, but is not limited to, RAM, ROM, EEPROM, flash memory or other memory technology, CD-ROM, digital versatile disks (DVD), or other optical disk storage, magnetic cassettes, magnetic tape, magnetic disk storage, or other magnetic storage devices, or any other medium which can be used to store the desired information and which can be accessed by server 114. Communication media typically embodies computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media such as acoustic, RF, infrared and other wireless media. Combinations of any of the above should also be included within the scope of computer readable media.

The computer storage media, including one or more databases 112 discussed above and illustrated in FIG. 1, provide storage of computer readable instructions, data structures, program modules, and other data for server 114. Server 114 may operate in a computer network 106 using logical connections to one or more client computers 102. Client computers 102 can be located at a variety of locations in a medical or clinical environment, for example, but not limited to, hospitals, other inpatient settings, testing labs, medical billing and financial offices, and hospital administrative sites. The client computers 102 may also be physically located in a nontraditional clinical laboratory or medical care environment so that the entire healthcare community is capable of integration on the network. Each client computer 102 may be a personal computer, server, router, a network PC, an interfaced instrument, a peer device or other common network node, and may include some or all of the elements described above relative to server 114. Network 106 may be a local area network (LAN) and/or a wide area network (WAN), but may also include other networks. Such networking environments are commonplace in offices, enterprise-wide computer networks, intranets and the Internet. When utilized in a WAN networking environment, server 114 may include a modem or other means for establishing communications over the WAN, such as the Internet. In a networked environment, program modules or portions thereof may be stored in server 114, or one or more databases 112, or on any of the client computers 102. For example, and not limitation, various application programs may reside in the memory associated with any one or all of client computers 102. It will be appreciated that the network connections shown are exemplary and other means of establishing a communications link between the computers may be used.

By way of example, a user may enter commands and information into server 114 or convey commands and information to the server 114 via client computers 102 through input devices, such as keyboards or pointing devices, commonly referred to as a mouse, trackball, or touch pad. Other input devices may include those accepting data from an interface or logic system, microphone, satellite dish, scanner or the like. Server 114 and/or client computers 102 may have any sort of display device, for instance, a monitor. In addition to a monitor, server 114 and/or client computers 102 may also include other peripheral output devices, such as speakers and printers.

Although many other internal components of server 114 and client computers 102 are not shown, those of ordinary skill in the art will appreciate that such components and their interconnection are well known. Accordingly, additional details concerning the internal construction of server 114 and client computers 102 need not be disclosed in connection with the present invention.

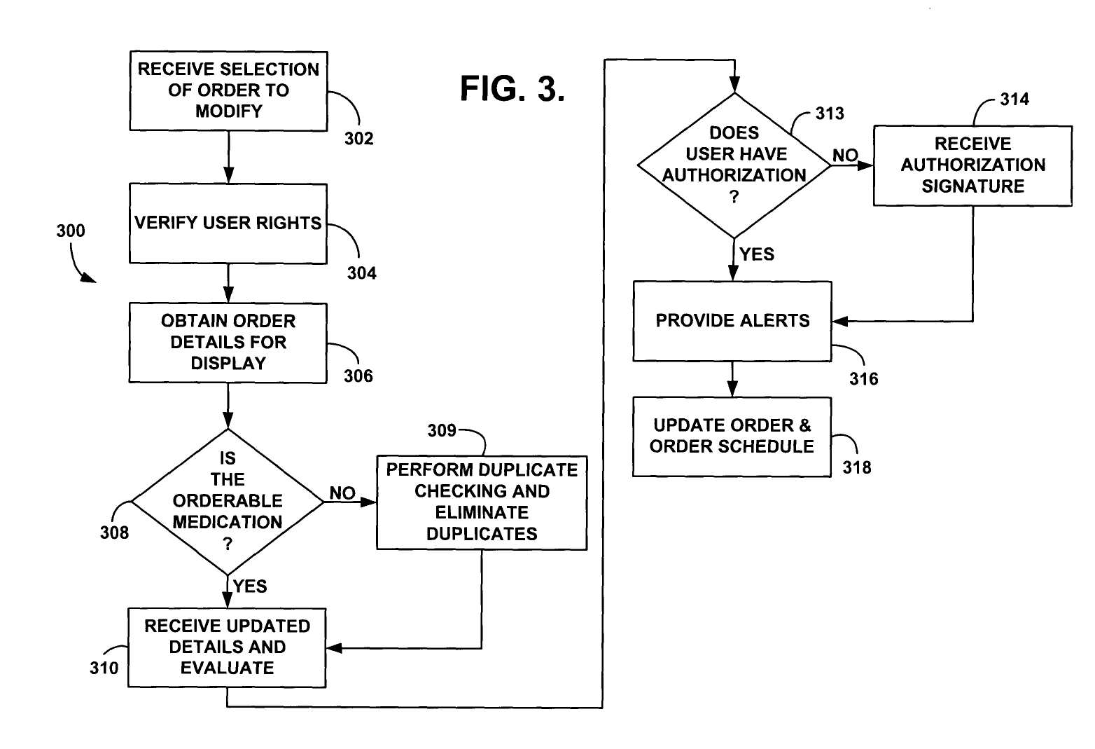

Referring to FIG. 3, a flow diagram 300 is provided that illustrates an embodiment of the present invention for dynamically modifying healthcare-related orders in accordance with the present invention. First, at block 302, the system receives a selection of an order for a clinical agent for modification. In other words, a user selects an order for a clinical agent prescribed to a patient to modify. The orders have previously been entered into the system. These orders may be entered by any of a variety of computerized physician order entry (CPOE) systems or on a number of other entry systems known in the art. Clinical agents as used herein include drugs, pharmaceuticals, nutriceuticals, salves, dietary supplements and the like.

Next, the order is verified at block 304. Verification includes a determination of whether the user has rights to access the order at block 302. After verifying the user's right to access the selected order, the order details are obtained and displayed at block 306 of FIG. 3. The system may access information regarding the order details from a database 112. The order details displayed may include the dose, dose unit, drug form, route of administration, frequency of administration, schedule of the order, and other information associated with the selected order. The user may make modifications to the details of the order. For example, the user may change the dose, dose unit, drug form, route of administration or frequency of administration. The user may make changes to one or more multiple details of the order.

At decision block 308, the system determines if the selected order is a medication or another orderable type. If the order is not medication, at block 309, duplicate checking is performed to ensure that the same order is not entered in the system in more than one instance.

Then, at block 310, the system receives the updated details for the order. For example, updated details for the order regarding include dose, dose unit, drug form, route of administration, frequency of administration, schedule of the order, and other information associated with the selected order may be received.

At block 310, the system evaluates the updated details for the order. In one embodiment, the system determines the validity and compatibility of the modified details. For example, the system may determine whether the dosage prescribed can be administered via the specified route based on manufacturer guidelines. The modified details may also be evaluated to determine if the order has been flagged with a particular warning or guideline at some point in its history and the conditions for the warning are satisfied. Or the system may determine if there is a risk associated with combining the modified order dosage with a second medication prescribed to the patient. The order details may also be evaluated to determine whether the modified order details satisfy manufacturer guidelines pertaining to the dosage of the modified medication or to determine if the modified order would exceed patient tolerance limits as determined by prior laboratory tests. The evaluation of the modified order details provides important safety benefits to the patient.

Next at decision block 313, the system determines if the user entering the modification had the authority to initiate the modification. If the user does not have authority, an authorizing signature for the modification is requested and if available, is obtained electronically at block 314.

Next at block 316, the system alerts the user of potential issues discovered while evaluating the modified order details at block 310. For example, if the system determines at block 310 that the patient cannot tolerate the modified dosage amount as determined by some prior laboratory tests, the user would be alerted at block 316. Once the system alerts the user at block 316, the user may choose from several courses of action including, but not limited to undoing the modification, presenting a new order, or overriding the alert and providing reasons for the deviation.

If there are no alerts at block 316 or the issue causing the alert condition has been resolved or explained, the order is updated at block 318. For example, if a modification to the dosage amount of an ordered medication is made, the system updates the order to reflect the modifications. If a modification is made to the frequency, frequency schedule or “as needed” (PRN) is made, an adjustment to the scheduled tasks for a patient is also made at block 318.

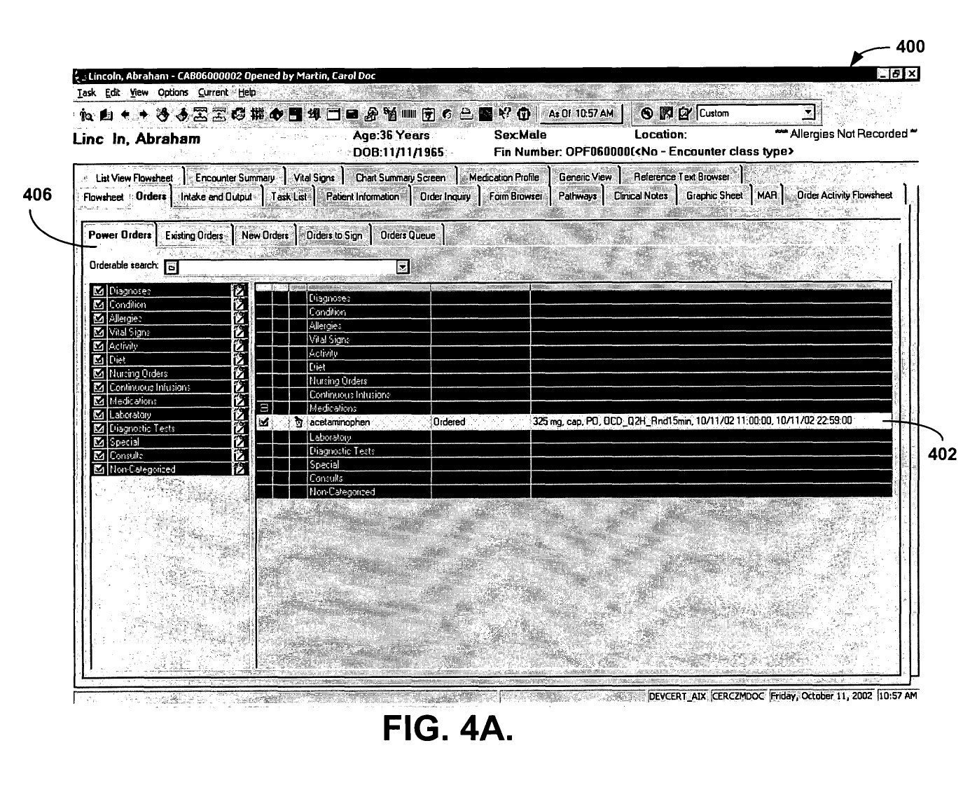

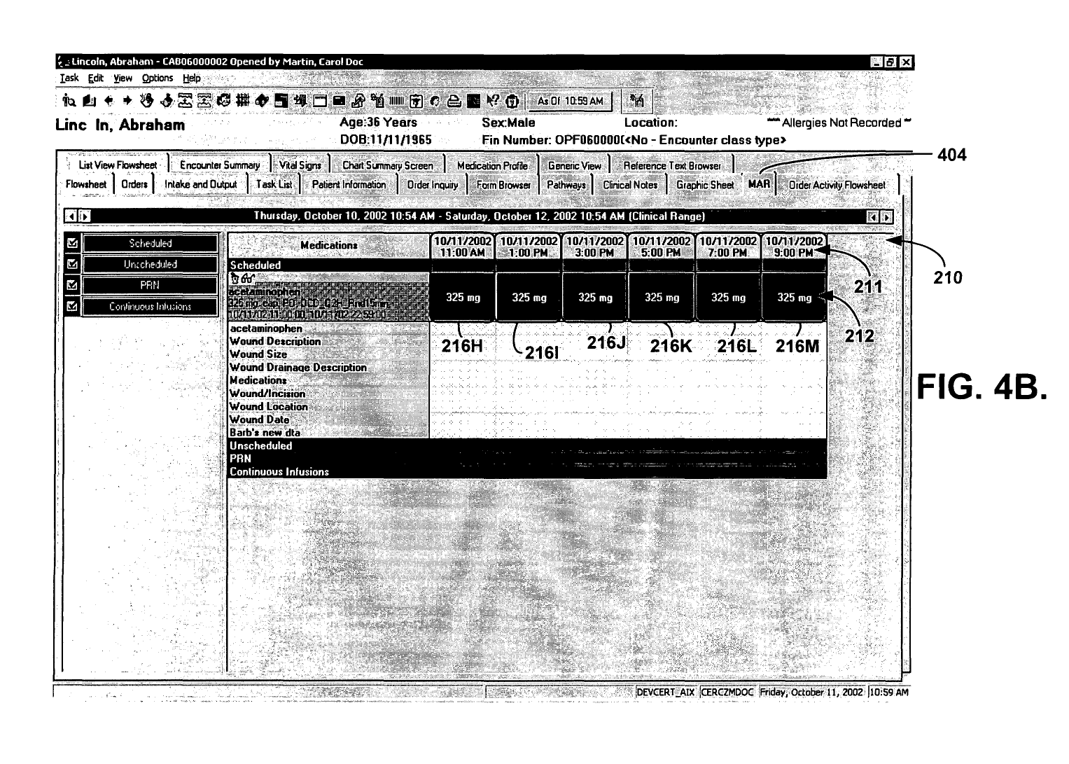

In operation, by way of example, FIG. 4A is a screen shot 400 of a patient order profile 406. Patient order profile 406 lists a variety of types of orders including orders regarding diagnosis, condition, allergies, vital signs, activity, diet, nursing order, continuous infusions, medications, laboratory, diagnostic tests, special, consults and non-categorized. In this example, the order profile 406 includes an entered order for the medication acetaminophen shown at an order display 402. The order details (including dosage, route, frequency, start time and stop time) are specified in the order sentence: “Acetaminophen 325 mg, cap, PO, OCD_Q2HRnd15 min, Oct. 11, 2002 11:00:00, Oct. 11, 2002 22:59:00.” In this example, the current order for the patient Abraham Lincoln is for 325 milligrams (325 mg) of acetaminophen by capsule (cap) delivered orally (PO) every two hours (Q2H). The order begins on Oct. 11, 2002 (Oct. 11, 2002) at 11:00 a.m. and expires on Oct. 11, 2002 (Oct. 11, 2002) at 22:59.

Order display 402 of FIG. 4A may be selected by the clinician. In this example, the selected order is displayed as part of a medication administration report (MAR) 404 as shown in FIG. 4B. The MAR 404 provides a concise summary of the tasks for the order for acetaminophen. The worksheet view 210 of the MAR 404 includes order tasks 216H-216M. Each order task 216H-216M includes the scheduled time for administration of the medication 211 and the dosage amount 212. In this example, according to the current order, 325 mg of acetaminophen is to be administered on Oct. 11, 2002 at 11:00 a.m. (216H), 1:00 p.m. (216I), 3:00 p.m. (216J), 5:00 p.m. (216K), 7:00 p.m. (216L) and the last dose is to be administered at 9:00 p.m. (216M). As can be seen in this example, the present invention provides for a concise summary of order tasks. Order tasks are displayed to enable accurate and efficient decisions by the clinicians providing care to patients.

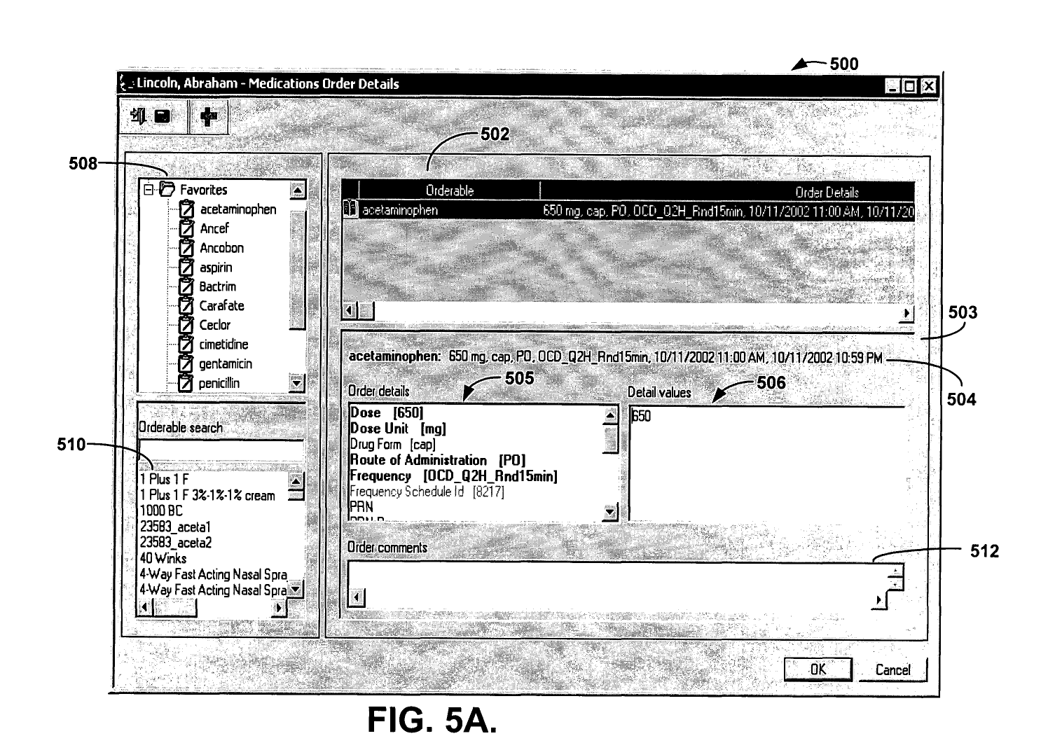

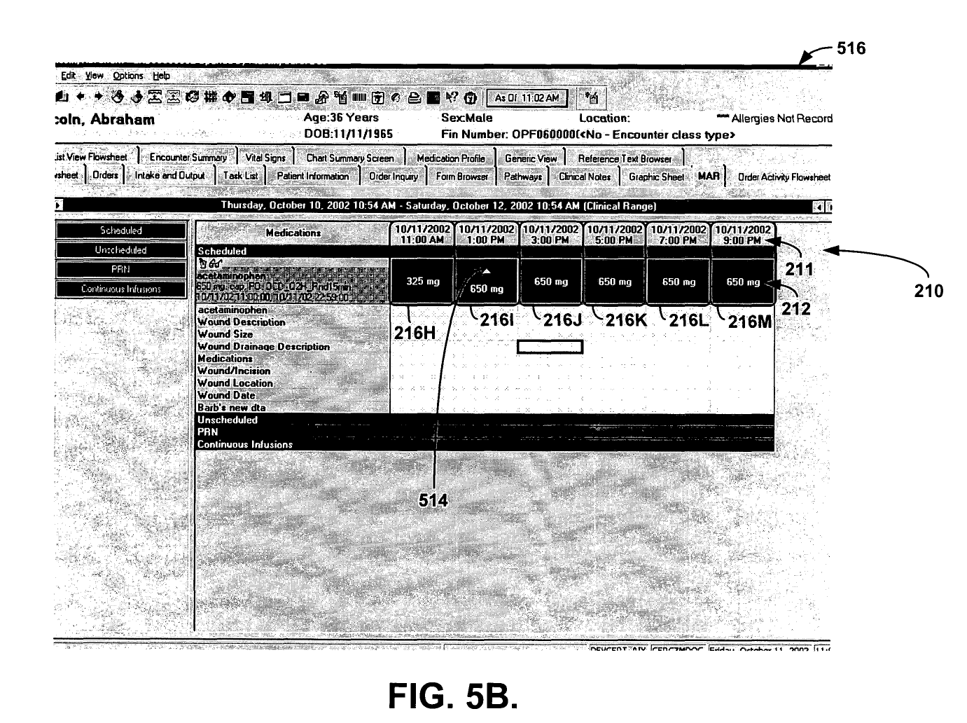

In this example, the user accesses order details by selecting order task 216H. Selection of order task 216H presents a new screen display as shown in FIG. 5A. Display 500 includes the details of the order and the modifiable parameters. Also, various Windows 502, 503, 504, 506, 508, 510 and 512 are presented to the user to facilitate the modification process. Order task window 502 presents the user with the details 505 of the order. Order detail window 503 displays the current details, including dose, dose unit, drug form, route of administration, frequency, and frequency schedule of the order. The order details are represented in the order sentence 504 and in order detail display 505. Order detail display 505 includes details of the order and in this example represents the modifiable details in brackets. When a particular order detail is selected in order detail display 505, the list of possible values are presented in detail value display 506. The detail value in display 506 may be modified to reflect any changes to be made to the order. The user is able to make changes to any of the order details including dose, dose unit, drug form, route of administration, frequency, and frequency schedule.

In this example, the dosage for acetaminophen in display 506 is modified from 325 mg to 650 mg. When the value in display 506 is changed, the change is reflected in the order sentence 504 and order details 505 of display 503 as well as the display 502. Order comments window 512 provides a field for entry of any information that a user has previously included or wants to include with the order. An example of an order comment is “Hold for diastolic blood pressure less than 75.” The modifications to the order details are then input into the system and the existing order may be updated to reflect the modifications.

With reference to FIG. 5B, display screen 516 is updated to reflect the updated order. In this example, the new dosage amount was received by the system after the 11:00 a.m. scheduled dosage. The system updates the order tasks after 11:00 a.m. (216I-216M) to reflect the new dosage amount of 650 mg. Order task 216H is not changed and reflects the original dosage amount of 325 mg. Delta indicator 514 identifies the modified order. The clinician is able to quickly and easily identify the initially ordered dosage of 325 mg and the modified dosage of 650 mg.

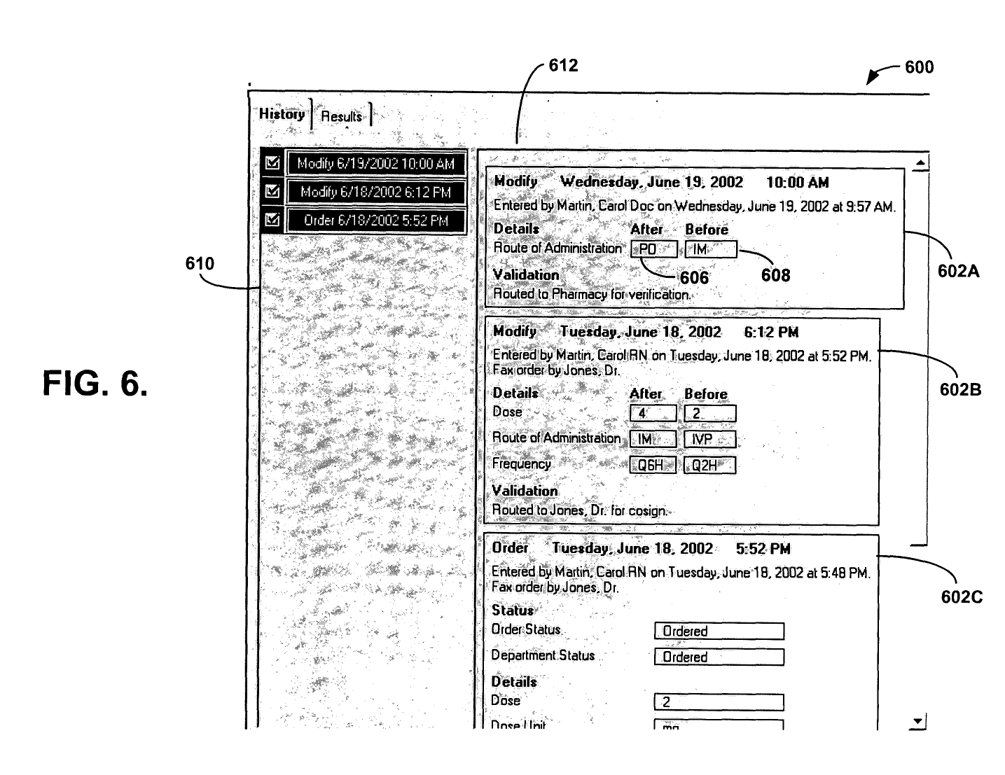

In a further aspect of the present invention, a historical view of the modifications to a patient's order is presented in FIG. 6. In this example, all of the order history is viewable in a concise view that displays both the order activity history and the context of the order. As shown, the historical display 600 presents information about the date and time the order was modified and the clinician who made the modification. The historical display 600 presents information in a historical listing window 610 and a detail area 612. The listing window 610 displays a list of actions for the order, and the time and date of each action

Detail area 612 includes a plurality of history windows 602A, 602B and 602C each representing a different activity that has occurred for the order. History windows 602A and 602B display historical information for modifications made to an existing order. The label “modify” in the upper left hand corner of history windows 602A and 602B identifies the historical order activities as modifications. History window 602C displays the originally placed order. The label “order” in the upper left hand corner of 602C identifies the order activity as the original order. For example, in history window 602A, the display indicates that the route of administration was modified from a value 606 of “PO” for per orum (by mouth) to a value 608 “IM” for intramuscular by Carol Martin on Wednesday, Jun. 19, 2002 at 9:57 a.m.

History window 602B shows that the dose, route of administration and frequency of the ordered medication were all modified by Carol Martin on Tuesday, Jun. 18, 2002 at 5:52. History window 602C displays information relating to an initial order placed by Carol Martin on Tuesday, Jun. 18, 2002 at 5:48.

From the foregoing, it can be seen that the process of the present invention allows an individual care provider to modify an order at a client computer. The invention processes the modification information and presents it to the user as a display of modified order details historically and in real time.

Advantages exist for several types of clinicians. A physician is able to easily view order histories and modify orders directly from the system. The evaluation and alerting process of the present invention eliminate errors that occur when existing orders are not cancelled when a modification occurs. Access to historical information and visual association of present and past orders enable graphing and analysis of trends and outcomes. For example, the effect of increased doses of morphine on the pain of a particular patient can be discerned more readily.

The system and method of the present invention also allows nurses to more easily understand the pattern of care being administered to a patient. The present invention eliminates errors associated with improper calculation of dosages and the timing of administering new orders relative to previous orders. A nurse is better able to manage the care plan of a patient, even when the treatment of the patient includes multiple orders that are changed frequently.

Also, the system and method of the present invention allows pharmacists to access and review modifications to an order immediately. Furthermore, the present invention enables the pharmacist to avoid unnecessary verification of modified orders. Because there is a display of exactly what has changed, the pharmacist can quickly determine if verification is necessary. Furthermore, the process of the present invention does not present changes for pharmacy verification if the modification is not clinically significant.

Also, the system and method of the present invention allow a quality officer to track and analyze order modification patterns and the reasons for the modifications. An audit trail is maintained with modified orders of the present invention as opposed to the canceled and re-specified orders of the prior art systems. Outcomes and order patterns can also be more readily analyzed using the system and method of the present invention.

The care process is also greatly improved by the present invention. The coordination of care is improved by the uncluttered MAR and the clean worksheet view (210 of FIG. 4B) displaying order details. Clinical workflows are more efficient because the emphasis shifts to workflow rather than inventory management. Physicians can quickly change medications to a less invasive route such as, from an Intravenous (IV) delivery to an oral delivery (PO) with little effort. As would be appreciated by those skilled in the art, various other efficiencies are also achieved through the present invention.

When a modification is performed according to the present invention, fewer order details need to be entered via the user interface. In other words, there is an expedited order entry process. For example, changing an order from PRN (pro re nata or “as needed”) to scheduled or vice-versa is effortless and the information is available in real-time.

Another benefit of the system and method of the present invention is the improvement in the accuracy of orders. By incorporating automated recalculations for modified dosage schedules, errors are prevented. The calculation for remaining doses in a modified order also improves patient safety.

Although the invention has been described with reference to the preferred embodiment illustrated in the attached drawing figures, it is noted that substitutions may be made and equivalents employed herein without departing from the scope of the invention as recited in the claims. For example, additional steps may be added and steps omitted without departing from the scope of the invention.

Similarly, while the invention has generally been described in terms of a single server, in embodiments one or more servers may host and respond to various parts of modification requests, and perform other actions. The database or other stores used to house the order information and other resources may be similarly distributed. The scope of the invention is accordingly intended to be limited only by the following claims.

We claim:

1. A method in a computing system for modifying healthcare-related orders, the method comprising:
receiving one or more modifications to an existing order for a clinical agent; and
updating the existing order to reflect said modifications.

2. The method of claim 1, wherein said clinical agent is one of a medication, drug, pharmaceutical, nutriceutical, dietary supplement or combinations thereof.

3. The method of claim 1, wherein said modifications include modifying the details of the order.

4. The method of claim 3, wherein the order details include one of the dose, dose unit, drug form, route of administration, frequency of administration and combinations thereof.

5. The method of claim 4, further comprising:
updating scheduled tasks for the existing order to reflect said modifications.

6. The method of claim 5, wherein said scheduled tasks include scheduled dosages of the clinical agent.

7. The method of claim 5, wherein only tasks scheduled after the time the one or more modifications were received are updated.

8. The method of claim 1, further comprising:
determining whether the user has authority to modify the order.

9. The method of claim 1, wherein the existing order is an order for a clinical agent to be administered to a patient.

10. The method of claim 9, further comprising:
evaluating the modifications to determine the validity of the modified details.

11. The method of claim 9, further comprising:
evaluating the modifications to determine the compatibility of the modified details with one or more other clinical agents ordered for the patient.

12. The method of claim 10, further comprising:
alerting the user if the modifications are invalid.

13. The method of claim 11, further comprising:
alerting the user if the modifications are not compatible with the one or more other clinical agents ordered for the patient.

14. The method of claim 7, further comprising:
displaying the order tasks that have not been updated.

15. The method of claim 14, further comprising:
displaying the updated order tasks.

16. The method of claim 15, further comprising:
displaying order tasks that have not been updated.

17. The method of claim 4, further comprising:
identifying historical information regarding the modifications to the existing order.

18. The method of claim 17, wherein the information includes identifying the user making the modification and the time and date of the modification.

19. The method of claim 17, wherein the information includes identifying the one or more order details prior to the modification and the one or more order details after the modification.

20. A system in a computing environment for modifying healthcare-related orders, the method comprising:
a receiving module for receiving one or more modifications to an existing order for a clinical agent; and
an updating module for updating the existing order to reflect said modifications.

21. The computer system of claim 20, wherein said clinical agent is one of a medication, drug, pharmaceutical, nutriceutical, dietary supplement or combinations thereof.

22. The computer system of claim 20, wherein said modifications include modifying the details of the order.

23. The computer system of claim 22, wherein the order details include one of the dose, dose unit, drug form, route of administration, frequency of administration and combinations thereof.

24. The computer system of claim 23, wherein the updating module updates scheduled tasks for the existing order to reflect said modifications.

25. The computer system of claim 24, wherein said scheduled tasks include scheduled dosages of the clinical agent.

26. The computer system of claim 25, wherein only tasks scheduled after the time the one or more modifications were received are modified.

27. The computer system of claim 20, further comprising:
a determining module for determining whether the user has authority to modify the order.

28. The computer system of claim 20, wherein the existing order is an order for a clinical agent to be administered to a patient.

29. The computer system of claim 28, further comprising:
an evaluating module for evaluating the modifications to determine the validity of the modified details.

30. The computer system of claim 28, further comprising:
an evaluating module for evaluating the modifications to determine the compatibility of the modified details with one or more other clinical agents ordered for the patient.

31. The computer system of claim 29, further comprising:
an alerting module for alerting the user if the modifications are invalid.

32. The computer system of claim 30, further comprising:
an alerting module for alerting the user if the modifications are not compatible with the one or more other clinical agents ordered for the patient.

33. The computer system of claim 26, further comprising:
displaying module for displaying the updated order.

34. The computer system of claim 33, wherein the displaying module displays the updated order tasks.

35. The computer system of claim 34, wherein the displaying module displays order tasks that have not been updated.

36. The computer system of claim 23, further comprising:
identifying information regarding the modifications to the existing order.

37. The computer system of claim 36, wherein the information includes identifying the user making the modification and the time and date of the modification.

38. The computer system of claim 36, wherein the information includes identifying the one or more order details prior to the modification and the one or more order details after the modification.

39. A method in a computing system for modifying healthcare-related orders, the method comprising:
means for receiving one or more modifications to an existing order for a clinical agent; and
means for updating the existing order to reflect said modifications.

40. The method of claim 39, further comprising:
means for evaluating the modifications.

41. The method of claim 40, further comprising:
means for identifying information regarding the modifications.

42. One or more computer-readable media having a method for modifying healthcare-related orders, the method comprising:
receiving one or more modifications to an existing order for a clinical agent; and
updating the existing order to reflect said modifications.
